(19) United States
(12) Patent Application Publication
(10) Pub. No.: US 2019/0356855 A1
(43) Pub. Date: Nov. 21, 2019

(54) WEBCAM APPARATUS AND MONITORING SYSTEM

(71) Applicant: PAWBO INC., TAIPEI CITY (TW)

(72) Inventors: Hung-Chin Hsiao, Taipei City (TW); Che-Yuan Cheng, Taipei City (TW); Chih-Hsien Teng, Taipei City (TW); Chin-Fu Huang, Taipei City (TW)

(73) Assignee: PAWBO INC., TAIPEI CITY (TW)

(21) Appl. No.: 16/027,287

(22) Filed: Jul. 4, 2018

(30) Foreign Application Priority Data
May 15, 2018 (TW) 107116410

(51) Int. Cl. H04N 5/232; H04N 5/14; A01K 5/02; G06T 7/20

(52) U.S. Cl. CPC H04N 5/23251; G06T 7/20; A01K 5/02; H04N 5/145

(57) ABSTRACT

A webcam apparatus and a monitoring system are provided. The webcam apparatus includes a camera, a processor, and a first communication module. The camera is configured to obtain a video screen. The processor is coupled to the camera. The processor analyzes the video screen. The first communication module is coupled to the processor. When the first communication module communicates with an electronic device, the first communication module outputs the video screen to the electronic device. When the processor determines that a moving object moves to a specific screen block in the video screen, the processor outputs a warning signal.

### CROSS-REFERENCE TO RELATED APPLICATION

This application claims the priority benefit of Taiwan application serial no. 107116410, filed on May 15, 2018. The entirety of the above-mentioned patent application is hereby incorporated by reference herein and made a part of this specification.

### BACKGROUND OF THE INVENTION

### 1. Field of the Invention

The invention relates to a camera apparatus, and more particularly, to a webcam apparatus and a monitoring system.

### 2. Description of Related Art

With the development of science and technology, more and more remote monitoring products have been developed. A common remote monitoring product has the function of providing real-time video information of a monitoring region, so that the user can watch the status of the monitoring region in real time. However, with the increase of various monitoring applications, the traditional video monitoring functions can no longer meet the user's monitoring needs. Therefore, several solutions are provided in the following embodiments.

### SUMMARY OF THE INVENTION

The invention provides a webcam apparatus and a monitoring system capable of providing a video screen in real time and automatically determining whether a moving object moves to a specific screen block in the video screen in order to correspondingly output a warning signal.

A webcam apparatus of the invention includes a camera, a processor, and a first communication module. The camera is configured to obtain a video screen. The processor is coupled to the camera. The processor analyzes the video screen. The first communication module is coupled to the processor. When the first communication module communicates with an electronic device, the first communication module outputs the video screen to the electronic device. When the processor determines that a moving object moves to a specific screen block in the video screen, the processor outputs a warning signal.

A monitoring system of the invention includes a webcam apparatus and an electronic device. The webcam apparatus includes a camera, a processor, and a first communication module. The camera is configured to obtain a video screen. The processor is coupled to the camera. The processor analyzes the video screen. The first communication module is coupled to the processor. The electronic device is configured to communicate with the first communication module and receive the video screen. When the processor determines that is moving object moves to a specific screen block in the video screen, the processor outputs a warning signal.

Based on the above, the webcam apparatus and the monitoring system of the invention can provide the video screen to the remote electronic device (e.g., a mobile phone, a tablet or a personal computer) in real time, and the webcam apparatus can analyze the video screen in real time, so as to determine whether it is required to prompt warnings. In other words, even if there is nobody watching the video screen, the webcam apparatus and the monitoring system of the invention can still automatically determine whether the moving object moves to the specific screen block sets by the user to thereby prompt warnings in real time.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a webcam apparatus according to an embodiment of the invention.

FIG. 2 is a side view of a webcam apparatus according to an embodiment of the invention.

FIG. 3A is a side view of a webcam apparatus according to another embodiment of the invention.

FIG. 3B is a top view of the webcam apparatus according to another embodiment of the invention.

FIG. 4 is a block diagram of a monitoring system according to an embodiment of the invention.

FIG. 5 is a schematic diagram of a video screen according to an embodiment of the invention.

FIG. 6 is a schematic diagram of a webcam apparatus according to another embodiment of the invention.

FIG. 7 is a block diagram of a monitoring system according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to make content of the present disclosure more comprehensible, embodiments are described below as the examples to prove that the present disclosure can actually be realized. Moreover, elements/components/steps with same reference numerals represent same or similar parts in the drawings and embodiments.

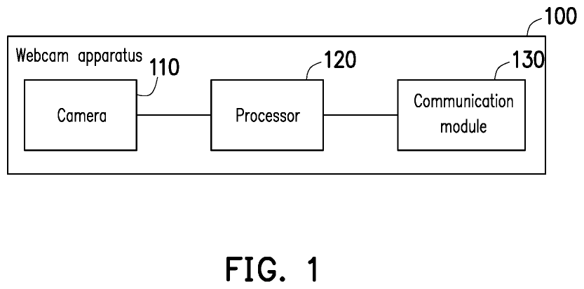

FIG. 1 is a schematic diagram of a webcam apparatus according to an embodiment of the invention. With reference to FIG. 1, a webcam apparatus 100 includes a camera 110, a processor 120, and a communication module 130. The processor 120 is coupled to the camera 110 and the communication module 130. In this embodiment, the webcam apparatus 100 is applicable to capture real-time video info nation of a specific region. The camera 110 may obtain a video screen and provide the video screen to the processor 120. The processor 120 provides the video screen to an external electronic device via the communication module 130, so that the user may watch the video screen remotely through the external electronic device. Further, the processor 120 may analyze the video screen to determine whether a moving object moves to a specific screen block in the video screen. When the moving object moves to the specific screen block, the processor 120 outputs a warning signal. In other words, the webcam apparatus 100 of the present embodiment may preset the specific screen block in the video screen, and sends out warnings such as sound, vibration or light when determining that the moving object moves to the specific screen block in the video screen.

In this embodiment, the moving object may be pet or human. For instance, one dangerous region may exist in the specific region. In this case, the user may monitor the specific region by using the webcam apparatus 100, and preset a screen block corresponding to the dangerous region as the specific screen in the video screen. In other words, when pet or human is close to or enters the dangerous region, the processor 120 of the webcam apparatus 100 may automatically determine whether the moving object moves to the specific screen through image analysis. Further, in this embodiment, the webcam apparatus 100 may automatically sends out warnings, so as to effectively prevent pet or human from entering the dangerous region.

In this embodiment, the camera 110 may include a CMOS (Complementary Metal-Oxide-Semiconductor) sensor or a CCD (Charge Coupled Device). The camera 110 of the present embodiment may be used for recording or providing a real-time video screen to the processor 120.

In the present embodiment, the processor 120 may be an image signal processor (ISP), a central processing unit (CPU), a system on chip (SOC) or other programmable devices for general purpose or special purpose, such as a microprocessor and a digital signal processor (DSP), a programmable controller, an application specific integrated circuit (ASIC), a programmable logic device (PLD) or other similar processing devices or a combination of the above. The invention is not limited in this regard.

In this embodiment, the communication module 130 may be a wireless communication circuit that supports Wi-fi communication standard. In this embodiment, the communication module 130 may first be connected to a network base station within a communication range, and may then communicate with the external electronic device through the network base station. Alternatively, in an embodiment, the communication module 130 may also communicate with the electronic device directly. The invention is not limited in this regard.

In this embodiment, the webcam apparatus 100 may further include a memory. The memory may be used for recording the video screen obtained by the camera 110. In this embodiment, the memory may be a non-transitory computer-readable recording medium. The non-transitory computer-readable recording medium may be Read-Only Memory (ROM), Electrically-Erasable Programmable Read-Only Memory (EPROM) or Electrically-Erasable Programmable Read-Only Memory (EEPROM). The invention is not limited in this regard. In this embodiment, the memory may be used for storing the video screen, analysis software and function software described in each embodiment of the invention, which may be read and executed by the processor 120.

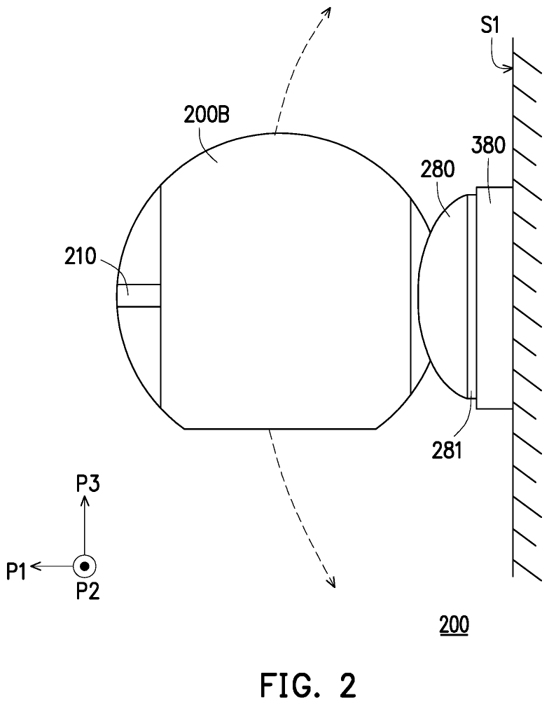

FIG. 2 is a side view of a webcam apparatus according to an embodiment of the invention. With reference to FIG. 2, a webcam apparatus 200 may include a device body 200B. The device body 200B is used to at least accommodate a camera 210, a processor (not shown), and a first communication module (not shown). In this embodiment, the device body 200B includes a rotation part 280. The device body 200B may have a sphere shape. The camera 210 is located on a first side of the device body 200B, and the rotation part 280 is located on a second side of the device body 200B. The first side is one side of the device body 200B facing a first direction P 1, and the second side is one side of the device body 200B facing opposite to the first direction P 1. The first side is opposite to the second side.

In this embodiment, the first direction P1, a second direction P2 and a third direction P3 are perpendicular to each other. A wall surface S1 is a plane formed in parallel with the second direction P2 and the third direction P3. Specifically, when a magnetic part 281 of the rotation part 280 is combined with a wall-mount part 380, the device body 200B is in a rotatable state. In other words, the webcam apparatus 200 may be disposed onto the wall surface S1, and the device body 200B of the webcam apparatus 200 may be rotated according different use requirements, so that the camera 210 may perform image sensing in a specific orientation.

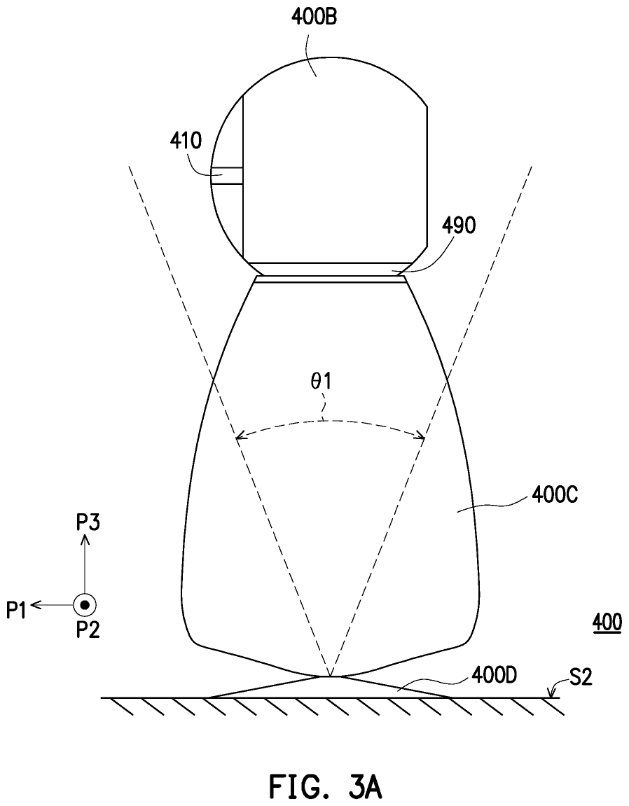

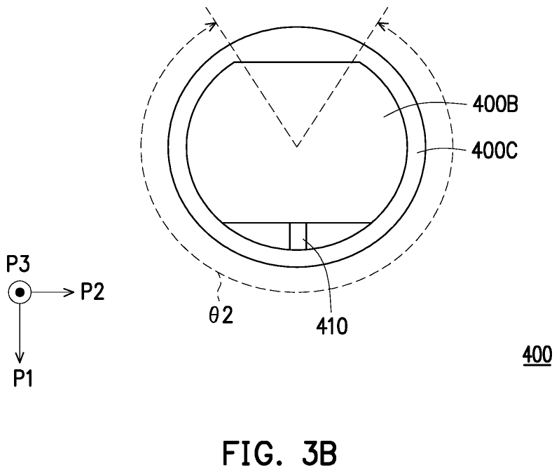

FIG. 3A is a side view of a webcam apparatus according to another embodiment of the invention. FIG. 3B is a top view of the webcam apparatus according to another embodiment of the invention. With reference to FIG. 3A and FIG. 3B, a webcam apparatus 400 may include a device body 400B, a docking station 400C and a base 400D. The device body 400B is used to at least accommodate a camera 410, a processor (not shown), and a first communication module (not shown). In this embodiment, the device body 400B includes a connection part 490. The camera 410 is located on a lateral side of the device body 400B, and the connection part 490 is located on a bottom portion of the device body 400B. In this embodiment, the camera 410 is located on one side of the device body 400B facing the first direction P1, and the bottom portion of the device body 400B may be a lateral side facing opposite to the third direction P3. The device body 400B may have a sphere shape. In this embodiment, the connection part 490 may include a plurality of connection terminals, and these connection terminals may be used for electrically connect with the docking station 400C when the connection part 490 is combined with the docking station 400C.

In this embodiment, the base 400D of the webcam apparatus 400 may be disposed on a desktop S2, for example. The docking station 400C is used for combining with the connection part 490 of the docking station 400B. When the base 400D is fixed to the desktop S2, the docking station 400C has a tiltable range θ1 in a vertical direction, and the docking station 400C has a rotatable range θ2 in a horizontal direction. Specifically, the tiltable range θ1 may be 30 degrees (±15 degrees based on the third direction P3). The rotatable range may be 310 degrees (with the first direction P1 and the second direction P2 as a rotation plane). In other words, the webcam apparatus 400 may be disposed onto a flat surface, and the device body 400B of the webcam apparatus 400 may be rotated or tilted according different use requirements, so that the camera 410 may perform image sensing in a specific orientation.

It should be noted that, the docking station 400C may further be a light source module, a storage module or an automatic feeder. For instance, the docking station may be the light source module configured to provide a lighting function. The light source module may include a light emitting diode (LED). As another example, the docking station 400C may be the automatic feeder configured to provide pet food. In other words, when the user is remotely monitoring pet through the webcam apparatus 400, the user may remotely control the docking station 400C of the webcam apparatus 400 to provide pet food.

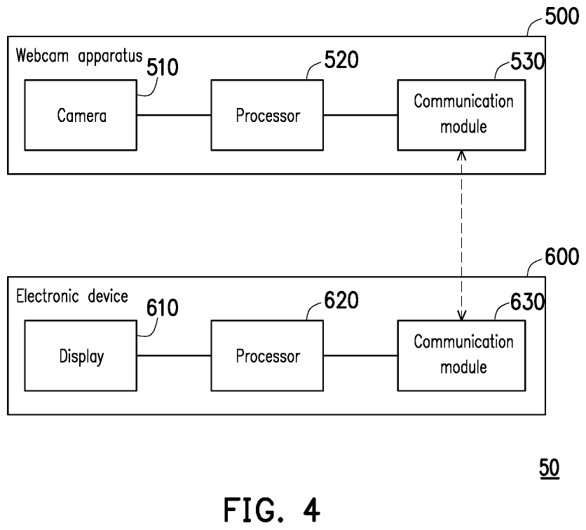

FIG. 4 is a block diagram of a monitoring system according to an embodiment of the invention. With reference to FIG. 4, a monitoring system 50 includes a webcam apparatus 500 and an electronic device 600. The webcam apparatus 500 includes a camera 510, a processor 520, and a communication module 530. The processor 520 is coupled to the camera 510 and the communication module 530. In this embodiment, the webcam apparatus 500 is suitable for monitoring video in a specific region. The camera 510 may obtain a video screen and provide the video screen to the processor 520. The processor 520 may provide the video screen to the external electronic device 600 via the communication module 530.

In this embodiment, the electronic device 600 includes a display 610, a processor 620 and a communication module 630. The electronic device 600 may be a mobile phone, a tablet, a portable computer or a desktop computer. The invention is not limited in this regard. In this embodiment, the communication module 530 and the communication module 630 support the same communication standard. The display 610 may be a liquid crystal display (LCD), a light emitting diode (LED) display, an organic light emitting diode (OLED) or other displays. The invention is not limited in this regard. In this embodiment, the display 610 is used for displaying the video screen in real time. Further, when the electronic device 600 receives an externally input screen selection signal, the processor 620 of the electronic device 600 returns a setting signal to the communication module 530 via the communication module 630, so that the processor 520 of the webcam apparatus 500 is able to set a position of the specific screen block in the video screen.

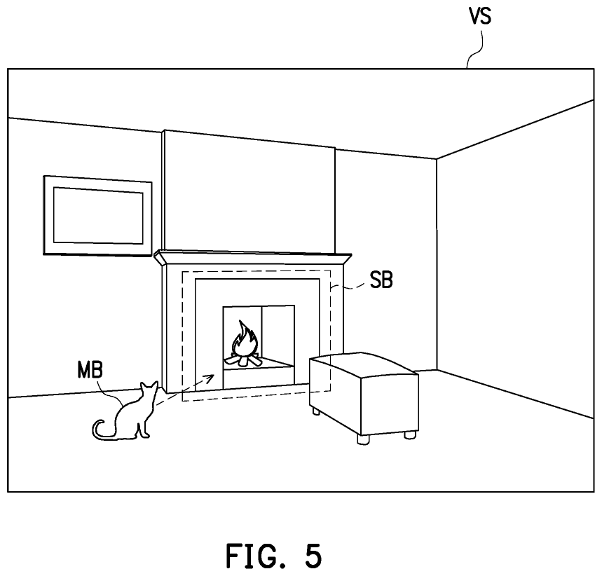

FIG. 5 is a schematic diagram of a video screen according to an embodiment of the invention. With reference to FIG. 4 and FIG. 5, FIG. 5 shows a video screen VS obtained by the webcam apparatus 500, and the video screen VS may be synchronously displayed on the display 610 of the electronic device 600. Specifically, the display 610 may be a touch display. The user may perform touch control on the display 610 to select a specific block screen SB in the video screen VS. The processor 620 of the electronic device 600 correspondingly generates the screen selection signal (including setting parameters) according to a selection result of the specific screen block SB and returns the screen selection signal to the webcam apparatus 500 via the communication module 630. The processor 520 of the webcam apparatus 500 may set video analysis software or video monitoring software according to the screen selection signal. Accordingly, when the processor 520 determines that a moving object MB moves to the specific screen block SB in the video screen VS, the processor 520 may output a warning signal in real time. In other words, the webcam apparatus 500 of the present embodiment may preset the specific screen block SB in the video screen VS, and determine whether the moving object MB moves to the specific screen block SB in the video screen VS to thereby send warnings such as sound, vibration or light.

For instance, as shown in FIG. 5, the video screen VS shows an indoor region and the indoor region includes a stove (the dangerous region). The user may perform settings on the corresponding screen displayed by the display 610 of the electronic device 600 to determine the position of the specific screen block SB in the video screen VS. The position of the specific screen block SB is a position corresponding to the stove. Therefore, when the moving object MB (e.g., a cat) moves to the specific screen block SB in the video screen VS, the processor 520 of the webcam apparatus 500 may output warnings to the electronic device 600 in real time. Alternatively, the webcam apparatus 500 may further include a sound player (not shown), and the sound player is coupled to the processor 520. When the processor 520 of the webcam apparatus 500 generates the warning signal, the webcam apparatus 500 may make sounds for warning through the sound player.

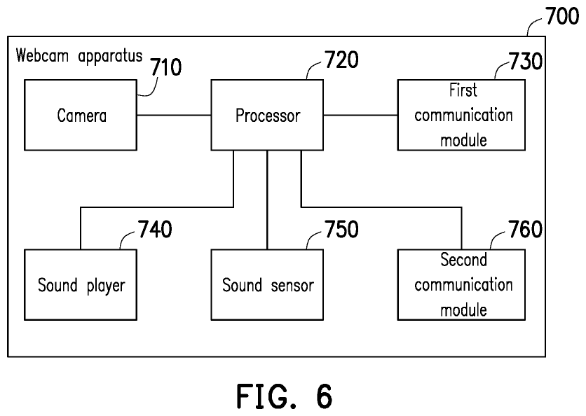

FIG. 6 is a schematic diagram of a webcam apparatus according to another embodiment of the invention. With reference to FIG. 6, a webcam apparatus 700 includes a camera 710, a processor 720, a first communication module 730, a sound player 740, a sound sensor 750 and a second communication module 760. The processor 720 is coupled to the camera 710, the first communication module 730, the sound player 740, the sound sensor 750 and the second communication module 760. The first communication module 730 and the second communication module 760 support different communication standards. In this embodiment, the camera 710 may obtain a video screen and provide the video screen to the processor 720. The processor 720 provides the video screen to an external electronic device via the first communication module 730, so that the user may remotely watch the video screen through the external electronic device. Further, in this embodiment, the processor 720 may analyze the video screen to determine whether a moving object moves to a specific screen block in the video screen. When the moving object moves to the specific screen block, the processor 720 outputs a warning signal. In other words, the webcam apparatus 700 of the present embodiment may preset the specific screen block in the video screen, and determine whether the moving object moves to the specific screen block in the video screen to thereby prompt warnings.

In this embodiment, the sound player 740 may be used for providing a sound message. For example, when the warning signal output by the processor 720 is received by the sound player 740, the sound player 740 correspondingly plays a warning sound. In this embodiment, the sound sensor 750 may be used for sensing a sound, and the sound may then be analyzed by the processor 720. For example, when the processor 720 determines that the sound meets a preset sound condition, the processor 720 may output a reminder signal to the external electronic device via the first communication module 730 to remind the user. For instance, when a pet sound is received by the sound sensor 750, sound processing software pre-built in the processor 720 may recognize whether the pet sound meets the preset sound condition to thereby provide corresponding reminder information for the user. In addition, the sound sensor 750 may also be used for receiving a sound message of the user, so that the processor 720 is able to perform voice recognition on the sound message of the user.

In this embodiment, the first communication module 730 may be a wireless communication circuit that supports Wi-fi communication standard, and the second communication module 760 may be a wireless communication circuit that supports Bluetooth. In this embodiment, the second communication module 760 may be used for communicating with an external peripheral apparatus. For instance, the sound sensor 750 may receive the sound message of the user, and then after going through the voice recognition, the processor 720 may output a control signal to the external peripheral apparatus via the second communication module 760 in order to remotely control the external peripheral apparatus. Alternatively, in an embodiment, the second communication module 760 may communicate with an external positioning device to receive a real-time positioning message. For instance, a monitoring target may wear the positioning device, so that the webcam apparatus 700 may receive a positioning signal of the monitoring target in real time via the second communication module 760. After the positioning signal is processed by the processor 720, the webcam apparatus 700 may provide the processed signal to the external electronic device via the first communication module 730. The monitoring target may be, for example, a pet, a baby or an elderly person. In other words, even if the monitoring target does not appear in the video screen, the user may still be aware of a position of the monitoring target.

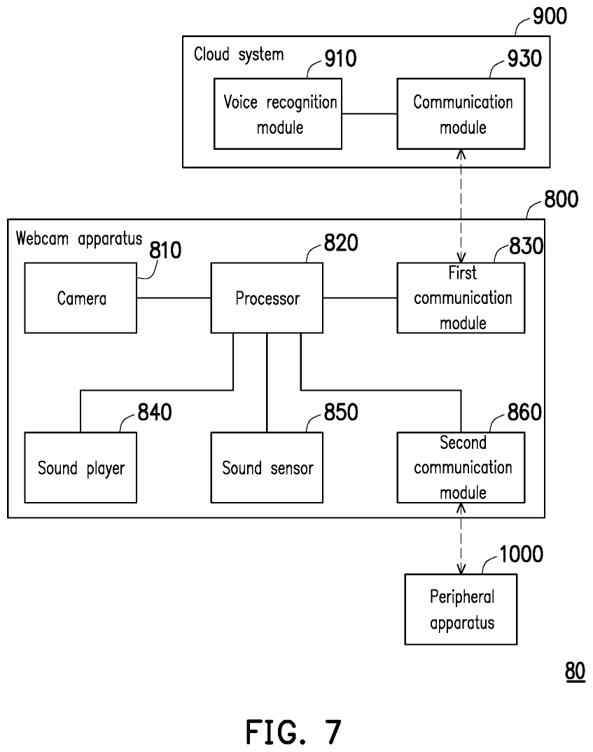

FIG. 7 is a block diagram of a monitoring system according to another embodiment of the invention. With reference to FIG. 7, a monitoring system 80 includes a webcam apparatus 800, a cloud system 900 and a peripheral apparatus 1000. In this embodiment, the webcam apparatus 800 includes a camera 810, a processor 820, a first communication module 830, a sound player 840, a sound sensor 850 and a second communication module 860. The processor 820 is coupled to the camera 810, the first communication module 830, the sound player 840, the sound sensor 850 and the second communication module 860. The first communication module 830 and the second communication module 860 may support different communication standards. In this embodiment, the cloud system 900 includes a voice recognition module 910 and a communication module 930. The voice recognition module 910 may apply a skill suite of Alexa Voice Service developed by Amazon or a skill suite based on Alexa Voice Service of Amazon, for example. However, the invention is not limited in this regard.

In this embodiment, the first communication module 830 may be a wireless communication circuit that supports Wi-fi communication standard, and the second communication module 860 may be a wireless communication circuit that supports Bluetooth. Specifically, the webcam apparatus 800 may be connected to a network base station through Wi-fi and connected to the communication module 930 of the cloud system 900 through the network base station. After the sound message of the user is received by the sound sensor 850, the webcam apparatus 800 may provide the sound message to the cloud system 900 via the first communication module 830. The cloud system 900 may analyze the sound message of the user, and return a corresponding voice recognition result to the webcam apparatus 800 via the second communication module 860. Accordingly, the webcam apparatus 800 may then execute a corresponding function according to the voice recognition result returned from the cloud system 900.

For instance, the peripheral apparatus 1000 may be an air conditioning apparatus, and the user may send out the sound message, which is a request to turn on the air conditioning apparatus, to the webcam apparatus 800. The webcam apparatus 800 provides the sound message to the cloud system 900, so that a corresponding control command may be generated by the voice recognition module 910. The cloud system 900 returns the corresponding control command to the webcam apparatus 800, so that the webcam apparatus 800 may output the corresponding control command to the peripheral apparatus 1000 via the second communication module 860 in order to turn on the air conditioning apparatus. In other words, the webcam apparatus 800 of the invention may also provide a remote voice control function.

It should be noted that, the webcam apparatus 800 of the invention may further record a connection history. Specifically, when the first communication module 830 finds a network base station within a communication range and the connection history recorded in the memory of the webcam apparatus 800 includes the connection history of that network base station, the first communication module 830 may be automatically connected to the network base station and further connected to the cloud system through the network base station. In other words, if the user has manually set an account name, a location or a login password of the network base station in the past, the processor 820 of the webcam apparatus 800 may record such a connection history. When the next time the user uses the webcam apparatus 800, the user does not need to re-enter the account name, the location, the login password of the network base station again. In other words, the webcam apparatus 800 of the invention may provide an automatic connection function.

In addition, enough teaching, suggestion, and implementation regarding technical features and video monitoring features of other functional devices in the webcam apparatus 800 of this embodiment may be obtained with reference to the foregoing embodiments of FIG. 1 to FIG. 6, which are not repeated hereinafter.

In summary, the webcam apparatus and the monitoring system of the invention may provide the video screen of the specific monitoring region in real time to the remote electronic device. After being set by the user, the webcam apparatus and the monitoring system of the invention may automatically determine whether the moving object moves to the dangerous region in the specific monitoring region to thereby prompt warnings in real time. Also, the webcam apparatus and the monitoring system of the invention may further provide functions like sound playing, sound sensing and remote controlling the peripheral apparatus. Moreover, the webcam apparatus of the invention may be used independently or in conjunction with the docking station. In this way, the webcam apparatus may be conveniently disposed on the wall surface or on the flat surface, so that the camera of the webcam apparatus may perform image sensing in a specific orientation. In addition, the docking station may be the light source module, the storage module or the automatic feeder, so as to provide diverse extension functions.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A webcam apparatus, comprising:
a camera, configured to obtain a video screen;
a processor, coupled to the camera, and configured to analyze the video screen; and
a first communication module, coupled to the processor, and configured to output the video screen to an electronic device when the first communication module communicates with the electronic device,
wherein when the processor determines that a moving object moves to a specific screen block in the video screen, the processor outputs a warning signal.

2. The webcam apparatus according to claim 1, further comprising:
a sound player, coupled to the processor, the sound player playing a warning sound when the warning signal output by the processor is received by the sound player.

3. The webcam apparatus according to claim 1, wherein the first communication module further outputs the warning signal to the electronic device when the first communication module communicates with the electronic device.

4. The webcam apparatus according to claim 1, further comprising:
a sound sensor, coupled to the processor, and configured to sense a sound message,
wherein the processor analyzes the sound message, and the processor outputs a prompt signal to the electronic device via the first communication module when the processor determines that the sound message meets a preset sound condition.

5. The webcam apparatus according to claim 1, wherein the processor outputs the sound message to a cloud system via the first communication module, and the cloud system comprises a voice recognition module,
wherein the voice recognition module analyzes the sound message in order to generate a voice recognition result, and the cloud system returns the voice recognition result to the first communication module, so that the processor executes a preset operation according to the voice recognition result.

6. The webcam apparatus according to claim 5, further comprising:
a second communication module, coupled to the processor, and configured to communicate with at least one peripheral apparatus,
wherein when the voice recognition result returned from the cloud system is received by the processor, the preset operation executed by the processor according to the voice recognition result is to output a control signal to the at least one peripheral apparatus via the second communication module.

7. The webcam apparatus according to claim 1, wherein the processor is further configured to record a connection history such that when the first communication module finds a network base station within a communication range and the connection history includes a connection record of the network base station, the first communication module automatically connects to the network base station and provide a communication function through the network base station.

8. The webcam apparatus according to claim 1, further comprising:
a device body, configured to accommodate the camera, the processor and the first communication module, the device body comprising a rotation part, wherein the camera is located on a first side of the device body, the rotation part is located on a second side of the device body, and the first side is opposite to the second side,
wherein when a magnetic part of the rotation part is combined with a wall-mount part, the device body is in a rotatable state.

9. The webcam apparatus according to claim 1, further comprising:
a device body, configured to accommodate the camera, the processor and the first communication module, the device body comprising a connection part, wherein the camera is located on a lateral side of the device body, and the connection part is located on a bottom portion of the device body; and
a docking station, comprising a base, wherein the docking station is configured to combine with the connection part of the device body, and the docking station is a light source module, a storage module or an automatic feeder,
wherein when the base of the docking station is fixed, the docking station has a tiltable range in a vertical direction and the docking station has a rotatable range in a horizontal direction.

10. The webcam apparatus according to claim 1, wherein the electronic device comprises a display, and the display is configured to display the video screen in real time, wherein when the electronic device receives an externally input screen selection signal, the electronic device returns a setting signal to the first communication module, so that the processor sets a position of the specific screen block in the video screen.

11. A monitoring system, comprising:
a webcam apparatus, comprising:
a camera, configured to obtain a video screen;
a processor, coupled to the camera, and configured to analyze the video screen; and
a first communication module, coupled to the processor; and
an electronic device, configured to communicate with the first communication module and receive the video screen,
wherein when the processor determines that a moving object moves to a specific screen block in the video screen, the processor outputs a warning signal.

12. The monitoring system according to claim 11, wherein the webcam apparatus further comprises:
a sound player, coupled to the processor, the sound player playing a warning sound when the warning signal output by the processor is received by the sound player.

13. The monitoring system according to claim 11, wherein the first communication module further outputs the warning signal to the electronic device when the first communication module communicates with the electronic device.

14. The monitoring system according to claim 11, wherein the webcam apparatus further comprises:
a sound sensor, coupled to the processor, and configured to sense a sound message,
wherein the processor analyzes the sound message, and the processor outputs a prompt signal to the electronic device via the first communication module when the processor determines that the sound message meets a preset sound condition.

15. The monitoring system according to claim 11, wherein the processor outputs the sound message to a cloud system via the first communication module, and the cloud system comprises a voice recognition module,
wherein the voice recognition module analyzes the sound message in order to generate a voice recognition result, and the cloud system returns the voice recognition result to the first communication module, so that the processor executes a preset operation according to the voice recognition result.

16. The monitoring system according to claim 15, wherein the webcam apparatus further comprises:
a second communication module, coupled to the processor, and configured to communicate with at least one peripheral apparatus,
wherein when the voice recognition result returned from the cloud system is received by the processor, the preset operation executed by the processor according to the voice recognition result is to output a control signal to the at least one peripheral apparatus via the second communication module.

17. The monitoring system according to claim 11, wherein the processor is further configured to record a connection history such that when the first communication module finds a network base station within a communication range and the connection history includes a connection record of the network base station, the first communication module automatically connects to the network base station and provide a communication function through the network base station.

18. The monitoring system according to claim 11, wherein the webcam apparatus further comprises:
a device body, configured to accommodate the camera, the processor and the first communication module, the device body comprising a rotation part, wherein the camera is located on a first side of the device body, the rotation part is located on a second side of the device body, and the first side is opposite to the second side,
wherein when a magnetic part of the rotation part is combined with a wall-mount part, the device body is in a rotatable state.

19. The monitoring system according to claim 11, wherein the webcam apparatus further comprises:
a device body, configured to accommodate the camera, the processor and the first communication module, the device body comprising a connection part, wherein the camera is located on a lateral side of the device body, and the connection part is located on a bottom portion of the device body; and
a docking station, comprising a base, wherein the docking station is configured to combine with the connection part of the device body, and the docking station is a light source module, a storage module or an automatic feeder,
wherein when the base of the docking station is fixed, the docking station has a rotatable range in a horizontal direction and the docking station has a tiltable range in a vertical direction.

20. The monitoring system according to claim 11, wherein the electronic device comprises a display, and the display is configured to display the video screen in real time, wherein when the electronic device receives an externally input screen selection signal, the electronic device returns a setting signal to the first communication module, so that the processor sets a position of the specific screen block in the video screen.
